(19) United States
(12) Patent Application Publication
(10) Pub. No.: US 2018/0136246 A1
(43) Pub. Date: May 17, 2018

(54) DEVICE, INSTRUMENT, AND METHOD FOR INDUCTIVE HEATING OF A SAMPLE FOR ANALYTE DETECTION

(71) Applicant: Quidel Corporation, San Diego, CA (US)

(72) Inventors: Scott Alexander Fall, San Diego, CA (US); Todd Denison Pack, San Diego, CA (US); Gregory Thomas Knipstein, Poway, CA (US)

(21) Appl. No.: 15/814,184

(22) Filed: Nov. 15, 2017

Related U.S. Application Data
(60) Provisional application No. 62/422,258, filed on Nov. 15, 2016.

(51) Int. Cl. G01N 35/10; B01L 3/00; G01N 1/44; B01L 7/04

(52) U.S. Cl. CPC G01N 35/10; B01L 3/5082; G01N 2035/00376; B01L 7/04; G01N 1/44

(57) ABSTRACT

Induction heating can be used facilitate reactions within biological samples. A sample container can be placed in a magnetic field from an induction coil to generate heat. An exemplary sample container can include an electrically insulative outer wall surrounding an interior space for containing a biological sample and a heating element within the interior space, the heating element comprising an electrically conductive portion. In use, the sample container can be received within a receptacle that includes the induction coil. The induction coil is operated to induce a current in the heating element of the sample container until the biological sample reaches a target temperature.

### CROSS-REFERENCE TO RELATED APPLICATIONS

This application claims the benefit of U.S. Provisional Application No. 62/422,258, filed Nov. 15, 2016, the entirety of which is incorporated herein by reference.

### TECHNICAL FIELD

The present disclosure generally relates to inductive heating for temperature control. In particular, the present disclosure relates to temperature control for facilitating reactions within biological samples.

### BACKGROUND

Systems which require multiple or cyclic chemical reactions in a biological sample to produce a desired product often require precise and accurate temperature control for the duration of the reactions. Such reactions can include, for example, nucleic acid amplification reactions such as polymerase chain reaction (“PCR”) and helicase-dependent amplification (“HDA”).

Sample preparation and processing can include a heating phase in which the sample is heated to a target temperature that promotes cell lysis and reduces the effect of inhibitory components of the sample, such as fresh mucus. At other phases of a cycle (e.g., denaturation, primer annealing, and primer extension), the temperature of the reaction mixture can be varied to maintain desirable reaction conditions.

### BRIEF SUMMARY

The subject technology is illustrated, for example, according to various aspects described below.

According to embodiments of the present disclosure, a non-contact heating system can provide efficient temperature control of a sample through inductive heating. By generating heat through electromagnetic induction, a sample can be brought to a target temperature in a short amount of time, held at the target temperature, and allowed to return to ambient temperature without contacting the sample with external devices and without adjusting the position of a sample container during the heating process. According to embodiments of the present disclosure, a heating system can heat a sample without requiring conduction of heat through an outer wall of a sample container, thereby reducing the criticality of interface requirements, such as the extent of surface contact and heat conductivity. According to embodiments of the present disclosure, the heating can promote cell lysis and reduce the effect of inhibitory components in the sample, such as fresh mucus.

According to some embodiments of the present disclosure, a sample container can include an electrically insulative outer wall surrounding an interior space for containing a biological sample and a heating element within the interior space, the heating element including an electrically conductive portion.

The heating element can further include an electrically insulative layer between the conductive portion and the interior space. The heating element can extend along a longitudinal axis of the outer wall. The heating element can be cylindrical. The heating element can be a hollow cylinder and a portion of the interior space is within the hollow cylinder. The heating element can be deposited on an inner surface of the outer wall. The sample container can includes an opening at a first end for receiving a biological sample, wherein the electrically conductive portion of the heating element is within a channel that includes a port at a second end of the sample container, opposite the first end, and wherein the electrically insulative layer is integral with the outer wall.

According to some embodiments of the present disclosure, a system can include a receptacle including an induction coil having a central axis; and a sample container including: an electrically insulative outer wall surrounding an interior space for containing a biological sample; and a heating element within the interior space, the heating element including an electrically conductive portion; wherein, when the sample container is placed within the receptacle, a central axis of the induction coil extends through the sample container.

When the sample container is placed within the receptacle, a central axis of the sample container can be aligned with the central axis of the induction coil. The system can further include a thermocouple configured to detect a temperature of the biological sample. The heating element can further include an electrically insulative layer between the conductive portion and the interior space.

According to some embodiments of the present disclosure, a method can include receiving, within a receptacle including an induction coil, a sample container including: an electrically insulative outer wall surrounding an interior space containing a biological sample; and a heating element within the interior space, the heating element including an electrically conductive portion; and with the induction coil, inducing a current in a heating element of the sample container until the biological sample reaches a target temperature.

Upon the receiving, a central axis of the induction coil can extend through the sample container. Upon the receiving, a central axis of the sample container can be aligned with a central axis of the induction coil. Inducing the current can include raising the temperature of the heating element above the target temperature for a duration of time. The heating element can span an entire height of the biological sample within the sample container. Inducing the current can include transmitting a plurality of sequential pulses of magnetic energy to the heating element. The target temperature can be sufficient to promote lysis of cells within the biological sample. The target temperature can be between 90° C. and 100° C. The target temperature can be sufficient to promote a reduction in activity of substances in the biological sample which inhibit molecular amplification. The biological sample can include a lysis buffer.

In addition to the exemplary aspects and embodiments described above, further aspects and embodiments will become apparent by reference to the drawings and by study of the following descriptions.

Additional embodiments of the present methods and compositions, and the like, will be apparent from the following description, drawings, examples, and claims. As can be appreciated from the foregoing and following description, each and every feature described herein, and each and every combination of two or more of such features, is included within the scope of the present disclosure provided that the features included in such a combination are not mutually inconsistent. In addition, any feature or combination of features may be specifically excluded from any embodiment of the present invention. Additional aspects and advantages of the present invention are set forth in the following description and claims, particularly when considered in conjunction with the accompanying examples and drawings.

### BRIEF DESCRIPTION OF THE DRAWINGS

FIG. 1 illustrates a perspective view of a sample container, according to some embodiments of the present disclosure.

FIG. 2 illustrates a sectional view of the sample container of FIG. 1, according to some embodiments of the present disclosure.

FIG. 3 illustrates a sectional view of the sample container of FIG. 1 with a biological sample, according to some embodiments of the present disclosure.

FIG. 4 illustrates a perspective view of a sample container, according to some embodiments of the present disclosure.

FIG. 5 illustrates a sectional view of the sample container of FIG. 4, according to some embodiments of the present disclosure.

FIG. 6 illustrates a sectional view of a sample container, according to some embodiments of the present disclosure.

FIG. 7 illustrates a sectional view of a sample container, according to some embodiments of the present disclosure.

FIG. 8 illustrates a sectional view of a sample container, according to some embodiments of the present disclosure.

FIG. 9 illustrates a sectional view of a sample container, according to some embodiments of the present disclosure.

FIG. 10 illustrates a sectional view of a sample container, according to some embodiments of the present disclosure.

FIG. 11 illustrates a sectional view of a sample container and inductive coil, according to some embodiments of the present disclosure.

FIG. 12 illustrates a sectional view of the sample container and inductive coil of FIG. 11, according to some embodiments of the present disclosure.

FIG. 13 illustrates a top view of a sample processing system, according to some embodiments of the present disclosure.

FIG. 14 illustrates a perspective view of a sample processing system, according to some embodiments of the present disclosure.

FIG. 15 illustrates a flowchart of a sample preparation, according to some embodiments of the present disclosure.

FIG. 16 illustrates a flowchart of a sample preparation, according to some embodiments of the present disclosure.

FIG. 17 illustrates a graph including results of the sample preparation of FIG. 16, according to some embodiments of the present disclosure.

FIG. 18 illustrates a flowchart of a sample preparation, according to some embodiments of the present disclosure.

FIG. 19 illustrates a graph including results of the sample preparation of FIG. 18, according to some embodiments of the present disclosure.

FIG. 20 illustrates a graph including results of the sample preparation of FIG. 18, according to some embodiments of the present disclosure.

FIG. 21 illustrates a graph including results of sample heating processes, according to some embodiments of the present disclosure.

### DETAILED DESCRIPTION

Various aspects now will be described more fully hereinafter. Such aspects may, however, be embodied in many different forms and should not be construed as limited to the embodiments set forth herein; rather, these embodiments are provided so that this disclosure will be thorough and complete, and will fully convey its scope to those skilled in the art.

One or more sample analysis techniques can be employed to achieve multiple or cyclic chemical reactions in a biological sample. To produce a desired product, precise and accurate temperature control can be performed for the duration of the reactions. Such reactions can include, for example, nucleic acid amplification reactions such as polymerase chain reaction (“PCR”) and helicase-dependent amplification (“HDA”).

PCR is a technique involving multiple cycles that result in the amplification of certain polynucleotide sequences. The PCR technique typically involves the step of denaturing a polynucleotide, followed by the step of annealing at least a pair of primer oligonucleotides to the denatured polynucleotide, i.e., hybridizing the primer to the denatured polynucleotide template. After the annealing step, an enzyme with polymerase activity catalyzes synthesis of a new polynucleotide strand that incorporates the primer oligonucleotide and uses the original denatured polynucleotide as a synthesis template. This series of steps (denaturation, primer annealing, and primer extension) constitutes a PCR cycle.

In HDA, a helicase enzyme is used to denature the DNA. Strands of double stranded DNA are first separated by a DNA helicase and coated by single stranded DNA (ssDNA)-binding proteins. Two sequence specific primers hybridize to each border of the DNA template. DNA polymerases are then used to extend the primers annealed to the templates to produce a double stranded DNA and the two newly synthesized DNA products are then used as substrates by DNA helicases, entering the next round of the reaction. A simultaneous chain reaction develops, resulting in exponential amplification of the selected target sequence.

Other analytic techniques can be performed, alone or in combination. Additional examples of analytic techniques include allele-specific PCR, assembly PCR, asymmetric PCR, dial-out PCR, digital PCR, helicase-dependent amplification, hot start PCR, intersequence-specific PCR, inverse PCR, ligation-mediated PCR, methylation-specific PCR, miniprimer PCR, multiplex ligation-dependent probe amplification, multiplex-PCR, nanoparticle-assisted PCR, nested PCR, overlap-extension PCR, PAN-AC, quantitative PCR, reverse transcription PCR, solid phase PCR, suicide PCR, thermal asymmetric interlaced PCR, and touchdown PCR. The present disclosure can be understood to provide heat and temperature control for these and other techniques, as desired to achieve a particular chemical reaction within a sample.

In order to efficiently process a sample, reagents of the sample should be brought to a desired reaction temperature quickly, the sample should be held at a desired temperature or desired temperatures for an appropriate amount of time, and the heating should be ceased rapidly.

A number of thermal “cyclers” used for DNA amplification and sequencing are available, in which one or more temperature controlled elements or “blocks” hold the reaction mixture, and wherein the temperature of the block is varied over time. These devices are slow in cycling the reaction mixtures and retain a large amount of heat after activity is ceased. In some systems, a thermocycler employs multiple temperature-controlled blocks that are kept at different temperatures, and reaction mixtures are moved between blocks. These systems have limited throughput capabilities, are physically large, and involve complex arrangements. Other methods include non-contact processes, such as hot air cycling, which is carried out by rapidly switching heated streams of air at the desired temperature. However, surrounding structures in the device will also become heated, and the temperature of the air must be significantly higher than the target temperature of the sample to achieve the target temperature.

Where preparation and transport of samples involves human interaction by a user, a heating cycle of long duration can interrupt workflow. Where the heating cycle requires several minutes to be completed, the user may be required to either wait for its completion or perform other tasks. When the user's attention is diverted from the heated sample, the user may not be prepared to remove the sample when the cycle is complete, potentially allowing residual heat from the device to be transferred to the sample. A short-duration heating cycle allows the user to remain focused on the cycle and improves overall throughput efficiency.

According to embodiments of the present disclosure, a non-contact heating system can provide efficient temperature control of a sample through inductive heating. By generating heat through electromagnetic induction, a sample can be brought to a target temperature in a short amount of time, held at the target temperature, and allowed to return to ambient temperature without contacting the sample with external devices and without adjusting the position of a sample container during the heating process. According to embodiments of the present disclosure, a heating system can heat a sample without requiring conduction of heat through an outer wall of a sample container, thereby reducing the criticality of interface requirements, such as the extent of surface contact and heat conductivity. According to embodiments of the present disclosure, the heating can promote cell lysis and reduce the effect of inhibitory components in the sample, such as fresh mucus.

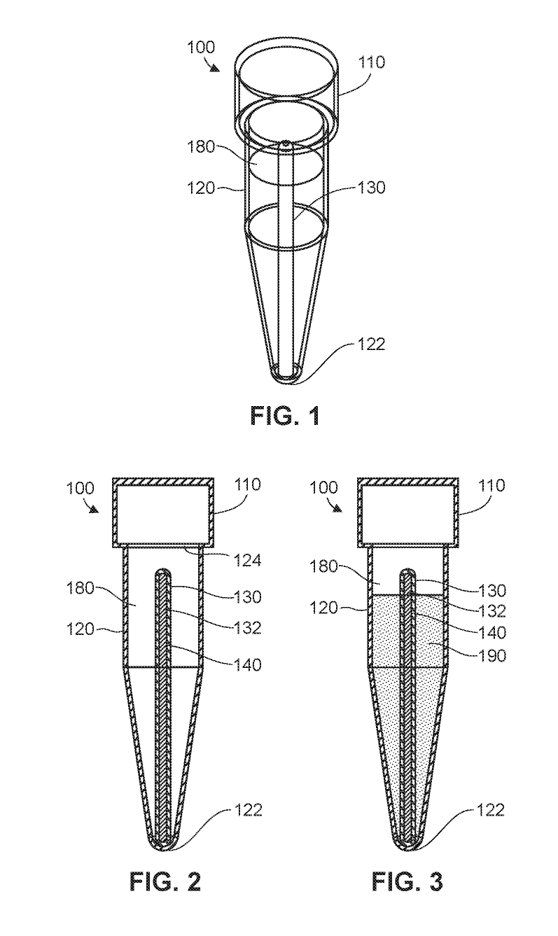

A sample container can facilitate heating of a biological sample from electromagnetic induction. FIGS. 1-3 illustrate a sample container 100, according to some embodiments of the present disclosure. According to some embodiments, for example as illustrated in FIG. 1, the sample container 100 can include an electrically insulative outer wall 120 surrounding an interior space 180 for containing a biological sample 190. The outer wall 120 can include an opening at a first end 124 and be closed at a second end 122, opposite the first end. A cap 110 can be provided to cover and seal the opening at the first end 124. Within the interior space 180, a heating element 130 can be positioned. The heating element 130 can include an electrically conductive core 132.

According to some embodiments, the electrically conductive core 132 can respond to magnetic fields by generating heat. Heat can be generated by eddy currents in the core 132, the eddy currents being induced wirelessly by an external induction circuit, as described further herein. The core 132, having generated heat, conducts the heat to the biological sample 190 directly or indirectly (e.g., via an intervening structure). Thus, an external induction circuit facilitates the heating without requiring contact with the biological sample 190 or the sample container 100 (e.g., the outer wall 120 and the core 132).

According to some embodiments, the core 132 can be in direct contact with the biological sample 190 (e.g., exposed to the interior space 180). Alternatively or in combination, the core 132 and the biological sample 190 can be separated by a protective material. For example, an electrically insulative layer 140 can be provided between the core 132 and the interior space 180. The layer 140 can cover the core 132, such that no portion of the core 132 is exposed to the interior space 180 or the biological sample 190. The layer 140 can protect the core 132 from the biological sample 190, for example to protect it from oxidation. The layer 140 can protect the biological sample 190 from the core 132. For example, the composition of the layer 140 can be non-reactive with respect to the biological sample 190. The layer 140 and/or the outer wall 120 can include, for example, a plastic and/or a polymer, such as parlyene, polyetheretherketone (PEEK), polytetrafluoroethylene (PTFE), polyimide, silicone, or combinations thereof. The layer 140 can provide heat conductivity between the core 132 and the biological sample 190.

According to some embodiments, the heating element 130 can evenly distribute heat throughout the biological sample 190. For example, as illustrated in FIGS. 2 and 3, the heating element 130 can extend along a longitudinal axis of the outer wall 120, such that the heating element 130 is radially equidistant from portions of the outer wall 120. By further example, the heating element 130 can have a height that spans, in at least one dimension, all or substantially all of a height of the biological sample 190, such that heat is generated along an entire height of the biological sample 190.

According to some embodiments, the heating element 130 be configured to optimize heat generation through flow of eddy currents. For example, the heating element 130 (e.g., the core 132) can have a minimum dimension (e.g., thickness) that is less than double a skin depth. Skin depth is related to the skin effect, which is caused by internal magnetic fields that are generated within a conductor, such as the core 132. Due to the skin effect, a decreasing portion of available conductor area is utilized as AC operating frequency is increased. This results in current flow that is more concentrated at the outer surfaces of a conductor as opposed to the interior portion of the conductor. The depth to which most of the current flow is constrained in a conductor operating at a given AC frequency is known as the skin depth and is given by equation:

$$δ = \sqrt{\frac{2 ρ}{f μ}}$$

where, δ is the skin depth (meters), ρ is the resistivity of conductor (Ohm-meters), f is the operating frequency (radians), and μ is the absolute magnetic permeability of conductor (Henries/meter). For a conductor of a thickness that is much thicker than the skin depth δ, much of the conductor is not utilized to pass AC current. The ratio of conductor thickness to skin depth δ is known as the skin depth ratio. Based on the minimum dimension of the heating element 130 (e.g., of the core 132), the heating element 130 can have a skin depth ratio of 2 or less, such that the minimum dimension does not exceed double the skin depth.

According to some embodiments, the heating element 130, or at least a portion thereof, can be straight, curved, helical, branched, or another shape. According to some embodiments, the heating element 130 can be cylindrical. According to some embodiments, the heating element 130 can be secured and fixed in a position relative to the outer wall 120. For example, the heating element 130 can be coupled to the outer wall 120 at or near the second end 122. According to some embodiments, more than one heating element 130 can be provided in a sample container 100.

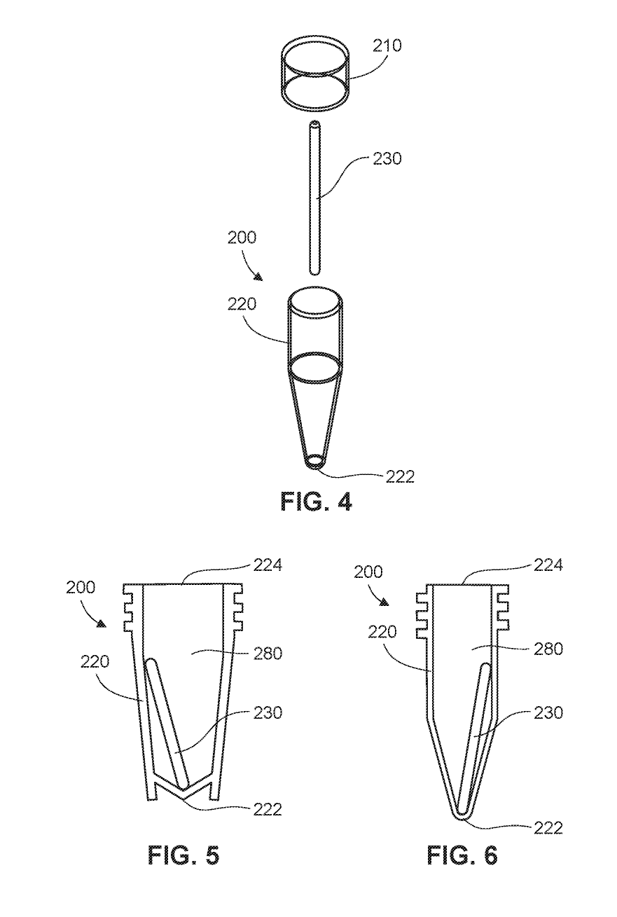

A sample container can include a heating element that is not fixed within the interior of the sample container. FIGS. 4-6 illustrate a sample container 200, according to some embodiments of the present disclosure. The sample container 200 can be similar in some respects to the sample container 100 of FIGS. 1-3 and therefore can be best understood with reference thereto. According to some embodiments, for example as illustrated in FIG. 4, the sample container 200 can include an outer wall 220, a heating element 230, and a cap 210. The heating element 230 can be inserted into an interior space 280 of the outer wall 220 through an opening at a first end 224 of the outer wall 220. The heating element 230 can include, optionally, an electrically insulative layer (not shown) that separates an electrically conductive core of the heating element 230 from the interior space 280 and/or a biological sample. As illustrated in FIGS. 5 and 6, the heating element 230 can rest within the interior space 280 at or near a second end 222 of the outer wall 220. The heating element 230 can remain unfixed with respect to the outer wall 220 throughout a heating process and be removed from the outer wall 220 after the completion of the heating process. The heating element 230 can move within the interior space 280, for example in response to movement of the sample container 200. As the heating element 230 moves within the interior space 280, it can agitate at least a portion of the biological sample within the sample container 200. According to some embodiments, more than one heating element 230 can be provided in the sample container 200.

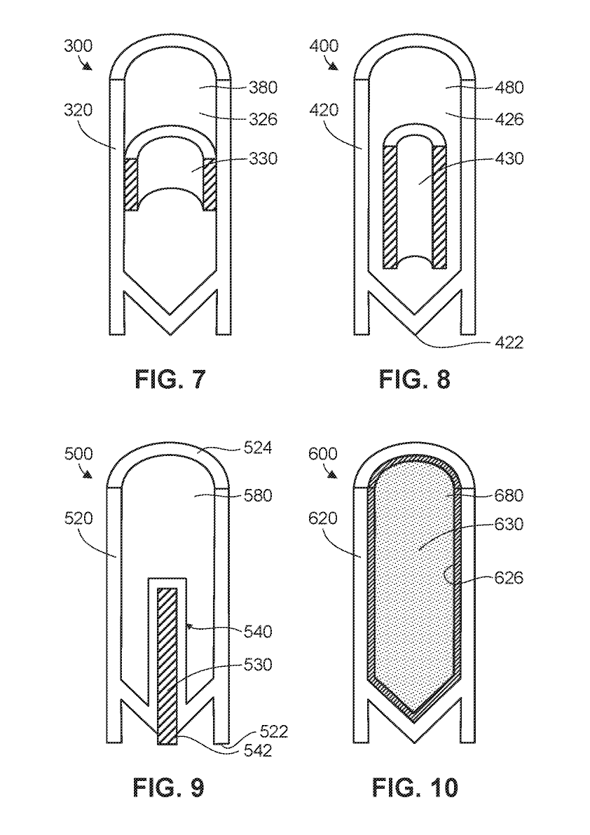

A sample container can include a heating element that is coupled to an inner surface of the sample container. FIG. 7 illustrates a sample container 300, according to some embodiments of the present disclosure. The sample container 300 can be similar in some respects to the sample container 100 of FIGS. 1-3 and therefore can be best understood with reference thereto. According to some embodiments, for example as illustrated in FIG. 7, the sample container 300 can include an outer wall 320 and a heating element 330. The heating element 330 can be coupled to an inner surface 326 of the outer wall 320. For example, the heating element 330 can be press fit into the outer wall 320. The heating element 330 can be a hollow cylinder (e.g., ring) and a portion of the interior space 380 can be within the hollow cylinder. The heating element 330 can include, optionally, an electrically insulative layer (not shown) that separates an electrically conductive core of the heating element 330 from the interior space 380 and/or a biological sample. The heating element 330 can have a height that is greater than, equal to, or less than a height of the biological sample, in at least one dimension. According to some embodiments, more than one heating element 330 can be provided in the sample container 300.

A sample container can include a heating element that provides multiple surfaces for exposure to the interior space of the sample container. FIG. 8 illustrates a sample container 400, according to some embodiments of the present disclosure. The sample container 400 can be similar in some respects to the sample container 100 of FIGS. 1-3 and therefore can be best understood with reference thereto. According to some embodiments, for example as illustrated in FIG. 8, the sample container 400 can include an outer wall 420 and a heating element 430. The heating element 430 can be in the shape of a hollow cylinder (e.g., ring) or another shape and a portion of the interior space 480 can be within the heating element 430. For example, the heating element 430 can provide both inner and outer surfaces to increase the surface area of the shape, compared to a solid shape of the same volume. The heating element 430 can remain unfixed with respect to the outer wall 420 throughout a heating process and be removed from the outer wall 420 after the completion of the heating process. Alternatively or in combination, a portion of the heating element 430 can be fixed with respect to the outer wall 420 (e.g., at an end 422), while the inner and outer surfaces of the heating element 430 remain exposed to the interior space 480 and/or the biological sample. The heating element 430 can include, optionally, an electrically insulative layer (not shown) that separates an electrically conductive core of the heating element 430 from the interior space 480 and/or a biological sample. The heating element 430 can have a height that is greater than, equal to, or less than a height of the biological sample, in at least one dimension. According to some embodiments, more than one heating element 430 can be provided in the sample container 400.

A sample container can include a heating element that is accessible outside of the interior space of the sample container. FIG. 9 illustrates a sample container 500, according to some embodiments of the present disclosure. The sample container 500 can be similar in some respects to the sample container 100 of FIGS. 1-3 and therefore can be best understood with reference thereto. According to some embodiments, for example as illustrated in FIG. 9, the sample container 500 can include an outer wall 520 and a heating element 530. The sample container 500 can further include an opening at a first end 524 for receiving a biological sample and a channel 542 with a port at a second end 522 of the sample container 500, opposite the first end 524. The heating element 530, or a portion thereof, can be received and reside within the channel 542. An electrically insulative layer 540 can be provided about at least a portion of the heating element 530. The layer 540 can be integral with the outer wall 520 and define boundaries of the channel 542. The heating element 530 can be removed from the channel 542 without accessing the internal space 580. The heating element 530 can have a height that is greater than, equal to, or less than a height of the biological sample, in at least one dimension. According to some embodiments, more than one heating element 530 can be provided to the sample container 500.

A sample container can include a heating element that is coupled to an inner surface of the sample container. FIG. 10 illustrates a sample container 600, according to some embodiments of the present disclosure. The sample container 600 can be similar in some respects to the sample container 100 of FIGS. 1-3 and therefore can be best understood with reference thereto. According to some embodiments, for example as illustrated in FIG. 10, the sample container 600 can include an outer wall 620 and a heating element 630. The heating element 630 can be coated onto an inner surface 626 of the outer wall 620. For example, the heating element 630 can define boundaries of an interior space 680 of the sample container 600. The heating element 630 can include a thin film deposited by, for example, chemical vapor deposition, sputtering, etc. According to some embodiments, all or a portion of the interior space 680 can be within the heating element 630. The heating element 630 can include, optionally, an electrically insulative layer (not shown) that separates an electrically conductive core of the heating element 630 from the interior space 680 and/or a biological sample. The heating element 630 can have a height that is greater than, equal to, or less than a height of the biological sample, in at least one dimension.

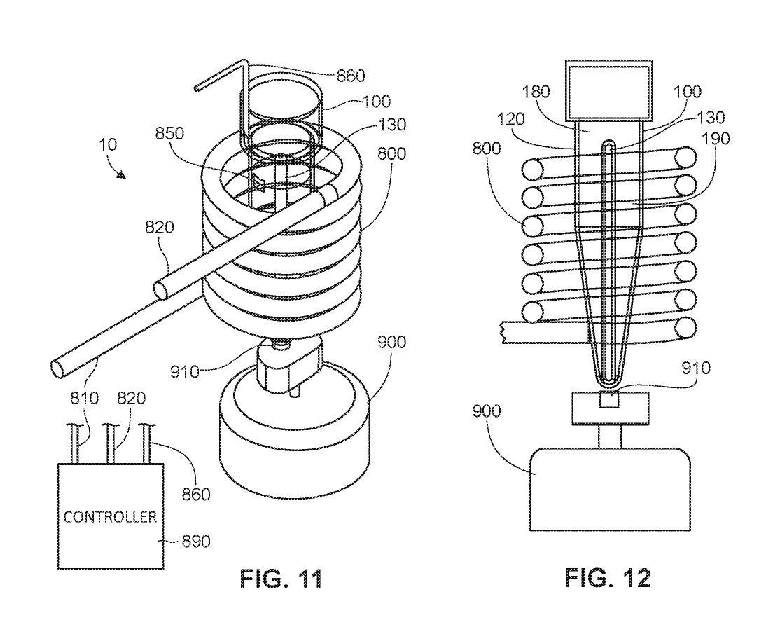

An induction coil can facilitate heating of the heating element. FIGS. 11 and 12 illustrate a system 10 including the sample container 100 within an induction coil 800, according to some embodiments of the present disclosure. According to some embodiments, for example as illustrated in FIGS. 11 and 12, the induction coil 800 is wound about an axis that is aligned with the sample container 100. For example, the central axis of the induction coil 800 can extend through the sample container 100 and/or be aligned with a central axis of the induction coil 800.

To operate the induction coil 800, the induction coil 800 is connected, by leads 810 and 820, to a controller 890 that includes an electronic oscillator. The oscillator passes a high-frequency alternating current (AC) through the induction coil 800. The rapidly alternating magnetic field penetrates the heating element 130, generating eddy currents within an electrically conductive portion (e.g., core 132) of the heating element 130. The eddy currents flowing through the resistance of the material heat it by Joule heating. In ferromagnetic materials, heat may also be generated by magnetic hysteresis losses. The magnetic energy can be transmitted continually and/or in sequential pulses for a period of time. The magnitude, frequency, and duration of the magnetic energy can be selected based on a target temperature and feedback, including sensed conditions of the biological sample. For example, a temperature of the biological sample and/or one or more components of the sample container 100 can be measured during a heating phase. A thermocouple 850 and/or other temperature sensing device can be provided in communication with the controller 890, for example, by a lead 860, to provide measurements as inputs to the controller 890. The thermocouple 850 can be provided within the interior space 180, for example in contact with the biological sample 190. By further example, the thermocouple 850 can be provided against an interior surface of the outer wall 120. The lead 860 can extend through the outer wall 120 and/or the cap 110. The electromagnetic energy can be provided until the actual temperature of the sample approaches or reaches a target temperature. The electromagnetic energy can be decreased or otherwise modified to maintain a temperature. The electromagnetic energy can be ceased when no further heating is desired. When the electromagnetic energy is ceased, only the residual heat within the sample container 100 remains, such that further heating is minimized after the electromagnetic energy is ceased.

The target temperature to be achieved can be sufficient to promote a reduction in activity of substances in the biological sample which inhibit molecular amplification (e.g., via PCR or HDA). Alternatively or in combination, the target temperature to be achieved can be sufficient to promote cell lysis. For example, the target temperature can be between 70° C. and 100° C. By further example, the target temperature can be between 80° C. and 100° C., 90° C. and 100° C., 70° C. and 95° C., 80° C. and 95° C., or 90° C. and 95° C. By further example, the target temperature can be 95° C.

According to some embodiments, while the sample container 100 is within the induction coil 800, at least a portion of the sample container 100 can contact and/or rest upon a platform 910 connected to a motor 900. Operation of the motor 900 can cause forces to be transmitted from the platform 910 to the sample container 100 to agitate or stir the sample within the sample container 100. The motor 900 can be operated simultaneously with and/or in sequence with operation of the induction coil 800. The agitation or stirring of the sample can facilitate even distribution of heat throughout the sample.

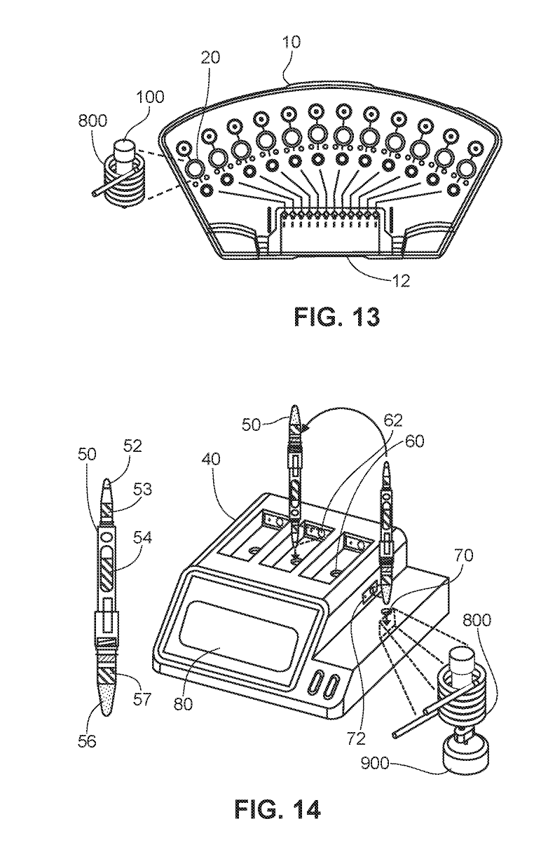

A system can include one or more induction coils and receive one or more sample containers. According to some embodiments, for example as illustrated in FIG. 13, a system 10 can include a plurality of receptacles 20. Each of the receptacles 20 can include an induction coil 800. When a sample container 100 is placed within one of the receptacles 20, the sample container 100 resides at least partially within the corresponding induction coil 800. The system 10 can include a controller 12 that provides a user interface and is in communication with an oscillator, the induction coils 800, the motors 900, and/or sensors.

A system can include multiple stations for handling a series of operations for a sample container. According to some embodiments, for example as illustrated in FIG. 14, a system 40 can include a first receptacle 70 and a second receptacle 60, each configured to receive and heat a different portion of a sample container 50 when received therein. The system 40 can include a controller 80 that provides a user interface and is in communication with components of the system 40.

According to some embodiments, a sample container 50 can include a sample chamber 56 that contains a biological sample and other substances, such as a chemical lysis buffer. The sample container 50 can also include a detection chamber on a side of the sample container 50 that is opposite the sample chamber 56. Between the sample chamber 56 and the detection chamber 52, the sample container 50 can include an inhibitor removal chamber 54, which contains an inhibitor removal substance within a breakable seal. Exemplary inhibitor removal substances include solutions containing mucolytic agents, such as acetylcysteine (NAC) and solutions containing chelating agents, such as ethylenediaminetetraacetic acid (EDTA). A pathway from the sample chamber 56 to the detection chamber 52 can pass through the inhibitor removal chamber 54.

According to some embodiments, when the sample container 50 is placed within the first receptacle 70, the sample container 50 can be oriented so that the sample chamber 56 is at a gravitational bottom of the sample container 50 and resides at least partially within the induction coil 800 and/or against a platform of the motor 900. Before, after, and/or during a residence of the sample chamber 56 within the first receptacle 70, a first optical device 72 can optically detect a characteristic of the sample chamber 56 and/or a first symbol 57 of the sample container 50.

According to some embodiments, the seal of the inhibitor removal chamber 54 can be broken, and the sample container 50 can be rotated and moved to the second receptacle 60. When the sample container 50 is placed within the second receptacle 60, the sample container 50 is oriented so that the detection chamber 52 is at a gravitational bottom of the sample container 50. The biological sample or can flow from the sample chamber 56, through the inhibitor removal chamber 54, and to the detection chamber 52. The second receptacle 60 can include thermocyclers that heat the biological sample. Before, after, and/or during a residence of the detection chamber 52 within the second receptacle 60, a second optical device 62 can optically detect a characteristic of the detection chamber 52 and/or a second symbol 53 of the sample container 50.

### EXAMPLES

The following examples are illustrative in nature and are in no way intended to be limiting.

It has been shown that HDA assays benefit from heating the sample to 95° C. This promotes cell lysis and reduces the effect of inhibitory samples such as those containing fresh mucus. In some systems, heating is performed for 5-10 minutes in a heat block which is at 95° C. Systems using inductive heating were compared to heat block systems as described below. The materials and equipment utilized include the following:
Thermocouple
Induction sealing equipment
10 mm 3003 aluminum thin walled tubing 5/16 OD (McMaster, Santa Fe Springs, Calif.)
416 Stainless steel dowel pins, 5/64″ OD×1″ length
Solana® instruments (Quidel Corporation, San Diego, Calif.)
Solana® Influenza A+B Assay Kit (Quidel Corporation, San Diego, Calif.)
Lyra® direct Strep A+C/G kits (Quidel Corporation, San Diego, Calif.)
SmartCycler® instrument (Cepheid Inc., Sunnyvale, Calif.)
PTFE coated stir bars, VP 734-2 and VP 735-2 (V&P Scientific, Inc., San Diego, Calif.)

### Example 1

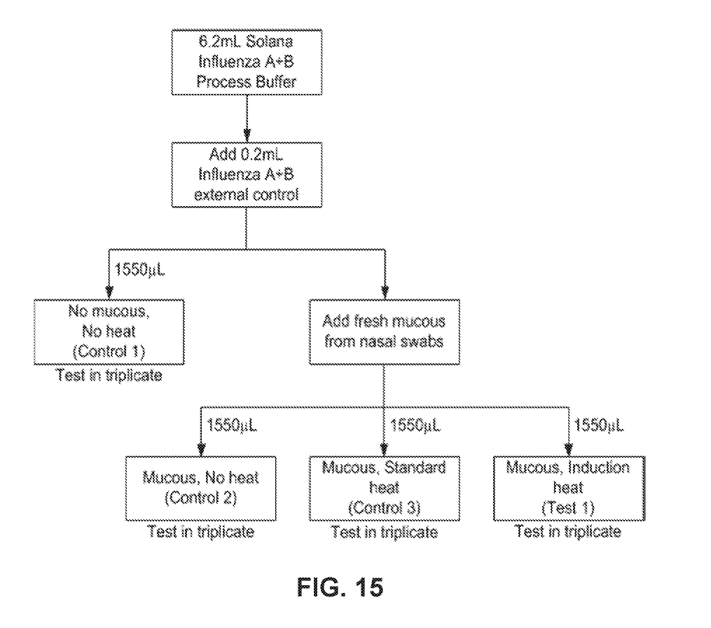

Samples were prepared in accordance with the flow chart of FIG. 15 and run in the Solana instrument using Solana Influenza A+B Assay according to manufacturer's instructions. The purpose of this experiment was to determine whether induction heating is able to reduce mucous-induced Solana Influenza A+B assay inhibition similarly to the standard 95° C. heat block. Samples which are induction heated had a single 10 mm 3003 aluminum thin walled tubing 5/16 OD added to the tube. Results for influenza A and influenza B samples are provided in the table below.

| | | | Average Minute |
|---|---|---|---|
| | | Minutes to | to Positive |
| Analyte | Test Condition | Positive Result | Result |
| Influenza A | No heat, no mucous | 25 | 26.0 |
| | | 27 | |
| | | 26 | |
| | No heat, with mucous | 28 | 28.0 |
| | | 28 | |
| | | 28 | |
| | 95° C. heat 5 minutes, | 24 | 23.3 |
| | with mucous | 23 | |
| | | 23 | |
| | Induction heat, with | 23 | 22.3 |
| | mucous | 22 | |
| | | 22 | |
| Influenza B | No heat, no mucous | 27 | 26.3 |
| | | 26 | |
| | | 26 | |
| | No heat, with mucous | 33 | 32.3 |
| | | 34 | |
| | | 30 | |
| | 95° C. heat 5 minutes, | 26 | 26.3 |
| | with mucous | 26 | |
| | | 27 | |
| | Induction heat, with | 25 | 26.0 |
| | mucous | 26 | |
| | | 27 | |

For both the influenza A and influenza B analytes the induction heat had the fastest time to result as compared to the controls. The induction heat performed similar to or better in removing assay inhibition caused by mucous than the standard heat block at 5 minutes, 95° C.

### Example 2

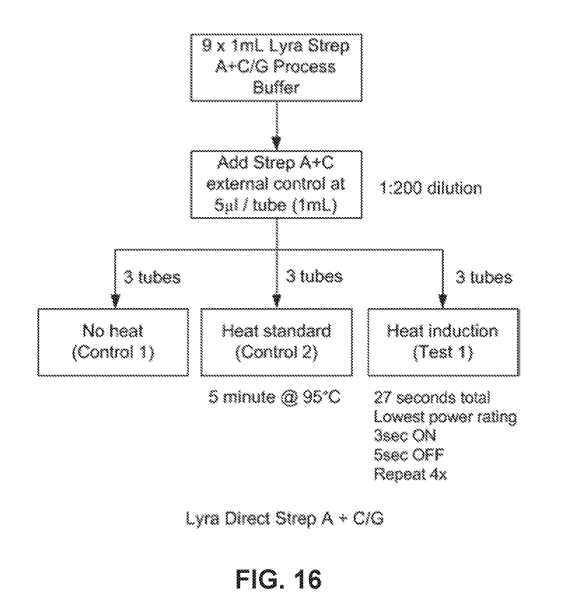

Samples were prepared in accordance with the flow chart of FIG. 16 and run in the SmartCycler instrument using Lyra Strep A+C/G kit according to manufacturer's instructions. The purpose of this experiment was to see whether induction heated samples behave similarly to samples heated in the heat block in accordance with the standard Lyra Direct Strep A+C/G procedure. Results for group A streptococcal samples are provided in the table below.

| Sample | Condition | Ct | Avg |
|---|---|---|---|
| 1 | Not Heated | 28.1 | 27.4 |
| 2 | | 27.3 | |
| 3 | | 26.9 | |
| 4 | 95° C. for 5 mins heat block | 24.4 | 24.1 |
| 5 | | 23.9 | |
| 6 | | 24.1 | |
| 7 | Induction heat to 95° C., 27 sec | 23.4 | 22.9 |
| 8 | | 21.9 | |
| 9 | | 23.3 | |

The induction heated sample showed a statistically significant improvement over both the heat block heated sample (p-value 0.03) and the non-heated sample (p-value <0.001) using a one sided t test. Results for a group C streptococcal sample are provided in the table below.

| Sample | Condition | Ct | Avg |
|---|---|---|---|
| 1 | Not Heated | — | 44.8 |
| 2 | | — | |
| 3 | | 44.8 | |
| 4 | 95° C. for 5 mins heat block | 33.6 | 31.1 |
| 5 | | 29.5 | |
| 6 | | 30.1 | |
| 7 | Induction heat to 95° C., 27 sec | 29.9 | 29.1 |
| 8 | | 26.3 | |
| 9 | | 31 | |

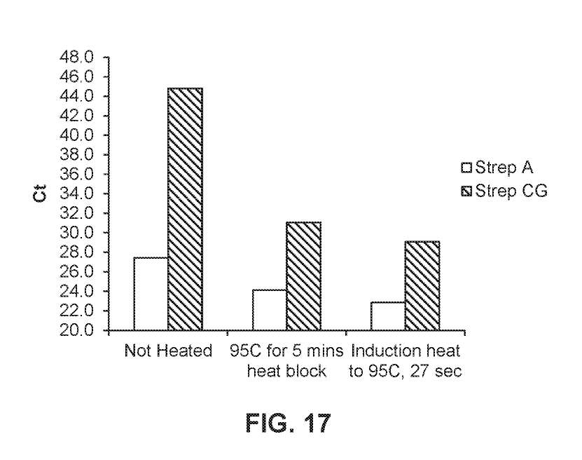

The induction heated sample showed no statistically significant improvement over the heat block heated sample (p-value 0.18) using a one sided t test, however both were significantly better than the non-heated sample (t.test cannot be done because only one replicate came up with a positive ct). A visual comparison of the results is provided in FIG. 17.

### Example 3

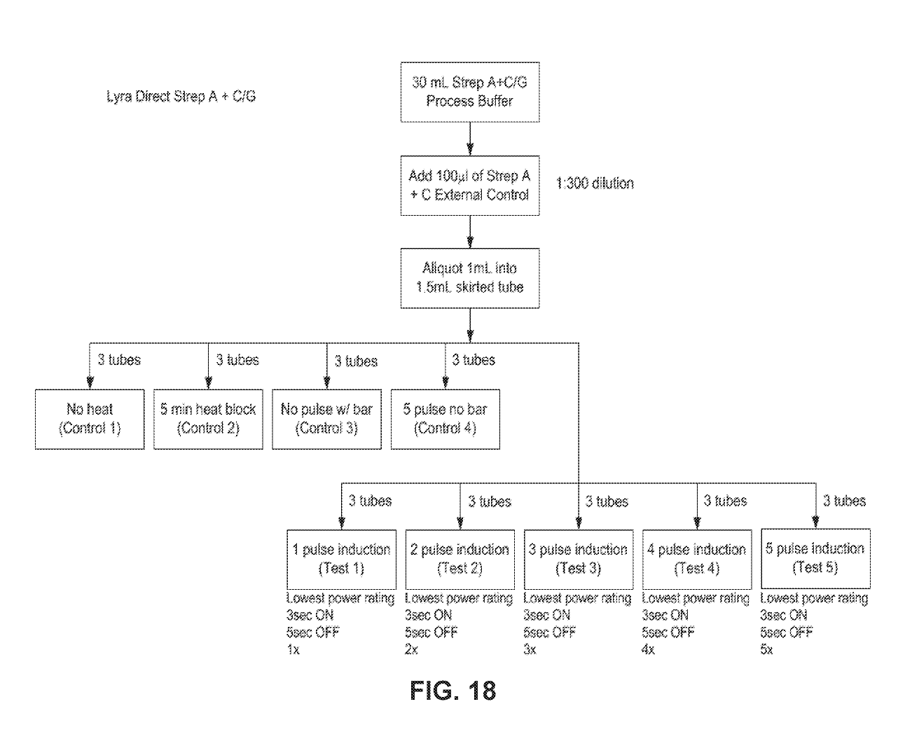

Samples were prepared in accordance with the flow chart of FIG. 18 and run in the Smart Cycler instrument using Lyra Strep A+C/G kit. The purpose of this experiment was to see how quickly the positive effects of heat emerge using the induction heating method. This was done by pulsing the induction heater on and off, varying the number of pulses. Results for a group A streptococcal sample are provided in the table below.

| Condition | Ct | Avg Ct |
|---|---|---|
| No Heat | 25.8 | 25.7 |
| | 25.8 | |
| | 25.5 | |
| 5 Min Block at 95° C. | 24.2 | 24.4 |
| | 24.7 | |
| | 24.4 | |
| No Pulse, with bar | 25.2 | 25.4 |
| | 25.7 | |
| | 25.2 | |
| 5 Pulse, No bar | 25.3 | 25.5 |
| | 25.7 | |
| | — | |
| 1 Pulse | 24.3 | 24.3 |
| | 24.2 | |
| | 24.4 | |
| 2 Pulse | 24 | 23.9 |
| | 23.7 | |
| | 24.1 | |
| 3 Pulse | 23.6 | 23.5 |
| | 23.6 | |
| | 23.3 | |
| 4 Pulse | 23.2 | 23.2 |
| | 23.1 | |
| | 23.3 | |
| 5 Pulse | 23.3 | 23.4 |
| | 23.6 | |
| | 23.2 | |

The 416 stainless steel bar did not seem to inhibit the assay, and pulsing the induction coil around the tube without the stainless steel bar did not seem to impact the assay. After two pulses with the induction coil, similar lysis to 5 minutes at 95° C. in a heat block is observed. After 4 pulses the maximum lysis is observed; it does not appear than there is any improvement past four pulses. Four pulses corresponds to approximately 27 seconds (3 seconds per pulse, 5 seconds pause between pulses). Results for a group C streptococcal sample are provided in the table below.

| Condition | Ct | Avg Ct |
|---|---|---|
| No Heat | — | 35.0 |
| | 33.7 | |
| | 36.3 | |
| 5 Min Block at 95° C. | 28.5 | 32.6 |
| | — | |
| | 36.7 | |
| No Pulse, with bar | 38.3 | 37.2 |
| | 38.4 | |
| | 34.8 | |
| 5 Pulse, No bar | — | 37.7 |
| | 36.6 | |
| | 38.8 | |
| 1 Pulse | — | 39.4 |
| | 39.4 | |
| | — | |
| 2 Pulse | 37.9 | 35.3 |
| | 31.7 | |
| | 36.2 | |
| 3 Pulse | 31.6 | 32.5 |
| | 33.9 | |
| | 32 | |
| 4 Pulse | 31.3 | 30.9 |
| | 29.5 | |
| | 31.9 | |
| 5 Pulse | 28.8 | 30.4 |
| | 30.4 | |
| | 31.9 | |

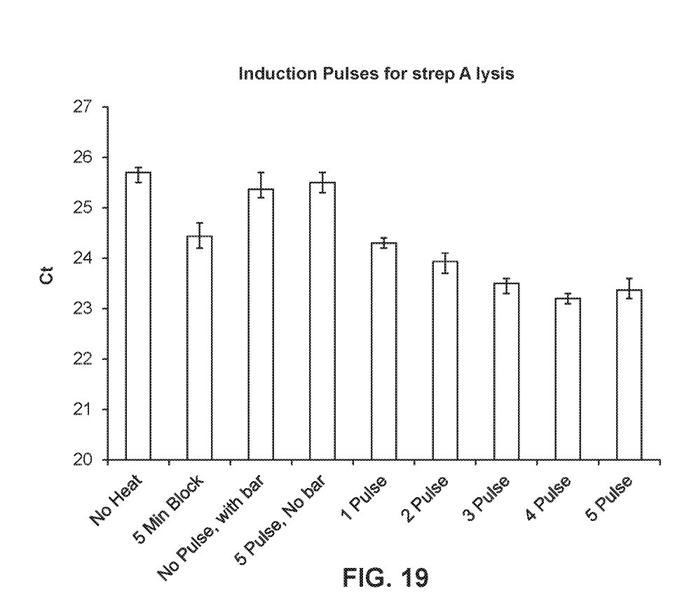

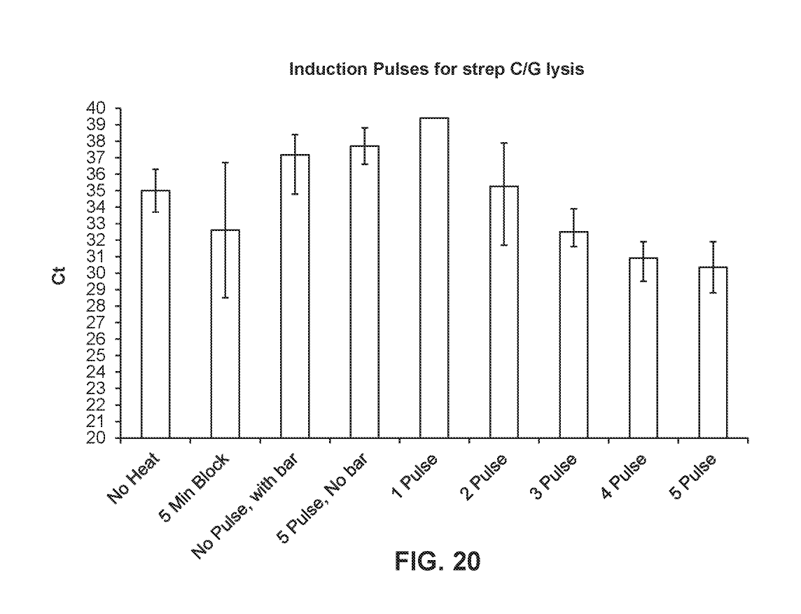

The 416 stainless steel bar did not seem to inhibit the assay, and pulsing the induction coil around the tube without the stainless steel bar did not seem to impact the assay. After three pulses with the induction coil, similar lysis to 5 minutes at 95° C. in a heat block is observed. After four pulses the maximum lysis is observed; it does not appear than there is any improvement past four pulses. Four pulses corresponds to approximately 27 seconds (3 seconds per pulse, 5 seconds pause between pulses). A visual comparison of the results is provided in FIGS. 19 and 20.

### Example 4

In this experiment the tubes contained a single 10 mm 3003 aluminum thin walled tubing of 5/16 OD. The purpose of this experiment was to determine if induction heating can remove inhibition observed with mucous in the Solana Strep Complete assay similarly to the standard 95° C. heat block. A control strain of Streptococcus dysgalactiae was combined with Solana Strep Complete Lysis Buffer and tested with no heat without mucous, no heat with mucous, 95° C. heat block with mucous and induction heat with mucous. Results for the Strep Complete Assay Streptococcus dysgalactiae C/G result are shown below.

| | | | Average |
|---|---|---|---|
| | | | Minute |
| | | Minutes to | to Positive |
| Analyte | Test Condition | Positive Result | Result |
| Streptococcus | No heat, no mucous | 12 | 13.3 |
| dysgalactiae C/G | | 12 | |
| | | 16 | |
| | No heat, with mucous | 17 | 13.7 |
| | | 12 | |
| | | 12 | |
| | 95° C. heat 5 minutes, | 11 | 11.0 |
| | with mucous | 11 | |
| | | 11 | |
| | Induction heat, with | 11 | 11.3 |
| | mucous | 11 | |
| | | 12 | |

While the mucous inhibition to this assay was minimal, the results demonstrate that the induction heat was similar in performance to the 95° C. heat for 5 minutes in a standard heat block.

### Example 5

In this experiment the total time, including induction pulse on and off times, for different volume configurations to reach 95° C. was measured. Coated dowel pins (VP Scientific) made of 304 stainless steel and coated in 0.02″ of Teflon (PTFE) plastic (to remain inert in many types of solutions) were inserted into buffer tubes listed below to act as the heating element. All tubes were polypropylene Starstedt tubes. Tubes were sealed with a screw cap with a hole for a thermocouple to contact the solution opposite of the heating element.

| | Total time | |
|---|---|---|
| Configuration | to 95° C. | Procedure |
| Solana Influenza A + B Process Buffer | 55 seconds | [5 seconds ON, 5 |
| configuration: | | seconds OFF] × 5, then 5 |
| 2 mL Skirted tube (label removed) filled with 1.6 mL | | seconds ON |
| deionized H2O, Teflon coated 304 SS rod, 2.5 mm | | |
| OD, 28.2 mm Length (PN: VP 734-2) | | |
| Solana Influenza Process Buffer configuration: | 35 Seconds | 15 seconds ON, then [5 |
| 2 mL Skirted tube (label removed) filled with 1.6 mL | | seconds OFF, 5 seconds |
| deionized H2O, Teflon coated 304 SS rod, 2.5 mm | | ON] × 2. |
| OD, 28.2 mm Length (PN: VP 734-2) | | |
| Solana Strep Complete Lysis Buffer configuration: | 25 seconds | [5 seconds ON, 5 sec |
| 1.5 mL conical tube (label removed) filled with 0.3 mL | | OFF] × 2, then 5 Sec ON |
| deionized H2O, Teflon coated 304 SS rod, 2.5 mm | | Note: temp reached 99° C. |
| OD, 21.8 mm Length (PN: VP 735-2) | | |
| Solana Strep Complete Lysis Buffer configuration: | 22 seconds | [4 seconds ON, 5 |
| 1.5 mL conical tube (label removed) filled with 0.3 mL | | seconds OFF] × 2, then 4 sec |
| deionized H2O, Teflon coated 304 SS rod, 2.5 mm | | ON |
| OD, 21.8 mm Length (PN: VP 735-2) | | Note: temp reached 92° C. |

The results demonstrate that even at large volumes (1.6 mL) heating to 95° C. occurs rapidly with a total time of 35 seconds. Thus, rapid heating to 95° C. can be achieved even using PTFE coated pins as the inductive heat element.

### Example 6

Induction heating techniques, as described herein, were applied to a variety of sample containers have different fill volumes. Similar sample containers were also used with a heating technique utilizing heat bocks. With the heat blocks, the heat was conducted to the sample through outer walls of the sample containers.

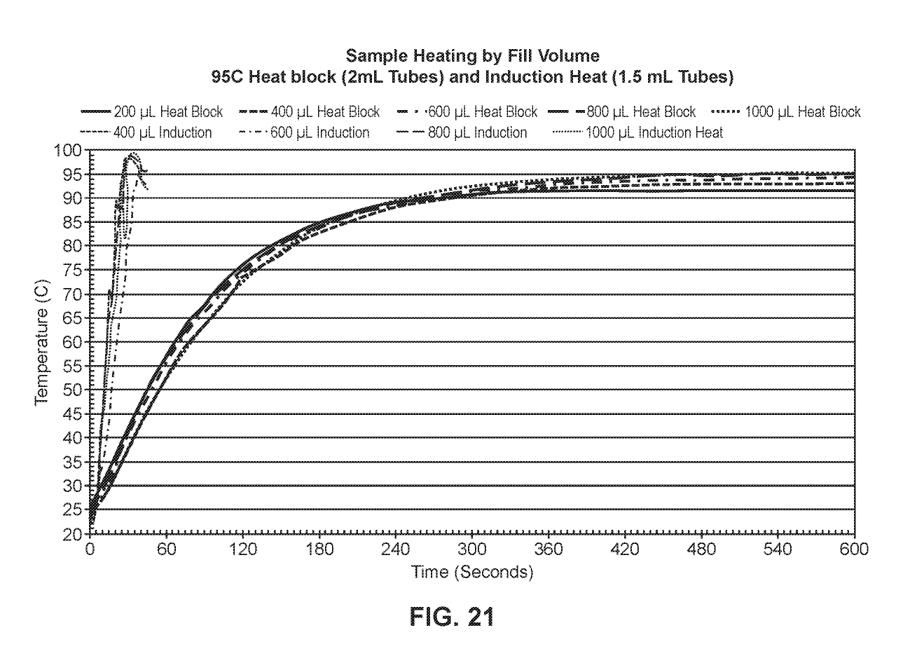

As shown in FIG. 21, the time required to achieve a target temperature (95° C.) was significantly shorter with the induction heating than with the heating blocks. Compared to the heat block techniques, the induction heating techniques showed an improved time by a factor of 10 or more. The reduction of time required to reach a target temperature reduces overall processing time, allows a user to remain focused on the process, and maintains control of the temperatures. Furthermore, the induction heating allows more rapid temperature decline on command.

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

A phrase such as “an aspect” does not imply that such aspect is essential to the subject technology or that such aspect applies to all configurations of the subject technology. A disclosure relating to an aspect may apply to all configurations, or one or more configurations. An aspect may provide one or more examples of the disclosure. A phrase such as “an aspect” may refer to one or more aspects and vice versa. A phrase such as “an embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples of the disclosure. A phrase such “an embodiment” may refer to one or more embodiments and vice versa. A phrase such as “a configuration” does not imply that such configuration is essential to the subject technology or that such configuration applies to all configurations of the subject technology. A disclosure relating to a configuration may apply to all configurations, or one or more configurations. A configuration may provide one or more examples of the disclosure. A phrase such as “a configuration” may refer to one or more configurations and vice versa.

There may be many other ways to implement the subject technology. Various functions and elements described herein may be partitioned differently from those shown without departing from the scope of the subject technology. Various modifications to these configurations will be readily apparent to those skilled in the art, and generic principles defined herein may be applied to other configurations. Thus, many changes and modifications may be made to the subject technology, by one having ordinary skill in the art, without departing from the scope of the subject technology.

It is understood that the specific order or hierarchy of steps in the processes disclosed is an illustration of exemplary approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

Terms such as “top,” “bottom,” “front,” “rear” and the like as used in this disclosure should be understood as referring to an arbitrary frame of reference, rather than to the ordinary gravitational frame of reference. Thus, a top surface, a bottom surface, a front surface, and a rear surface may extend upwardly, downwardly, diagonally, or horizontally in a gravitational frame of reference.

Furthermore, to the extent that the term “include,” “have,” or the like is used in the description or the claims, such term is intended to be inclusive in a manner similar to the term “comprise” as “comprise” is interpreted when employed as a transitional word in a claim.

The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” Pronouns in the masculine (e.g., his) include the feminine and neuter gender (e.g., her and its) and vice versa. The term “some” refers to one or more. Underlined and/or italicized headings and subheadings are used for convenience only, do not limit the subject technology, and are not referred to in connection with the interpretation of the description of the subject technology. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While certain aspects and embodiments of the subject technology have been described, these have been presented by way of example only, and are not intended to limit the scope of the subject technology. Indeed, the novel methods and systems described herein may be embodied in a variety of other forms without departing from the spirit thereof. The accompanying claims and their equivalents are intended to cover such forms or modifications as would fall within the scope and spirit of the subject technology.

What is claimed is:

1. A system, comprising:
a receptacle comprising an induction coil having a central axis; and
a sample container comprising:
an electrically insulative outer wall surrounding an interior space for containing a biological sample; and
a heating element within the interior space, the heating element comprising an electrically conductive portion;
wherein, when the sample container is placed within the receptacle, a central axis of the induction coil extends through the sample container.

2. The system of claim 1, wherein, when the sample container is placed within the receptacle, a central axis of the sample container is aligned with the central axis of the induction coil.

3. The system of claim 1, further comprising a thermocouple configured to detect a temperature of the biological sample.

4. The system of claim 1, wherein the heating element further comprises an electrically insulative layer between the conductive portion and the interior space.

5. A sample container, comprising:
an electrically insulative outer wall surrounding an interior space for containing a biological sample; and
a heating element within the interior space, the heating element comprising an electrically conductive portion.

6. The sample container of claim 5, wherein the heating element further comprises an electrically insulative layer between the conductive portion and the interior space.

7. The sample container of claim 6, wherein the sample container comprises an opening at a first end for receiving a biological sample, wherein the electrically conductive portion of the heating element is within a channel that comprises a port at a second end of the sample container, opposite the first end, and wherein the electrically insulative layer is integral with the outer wall.

8. The sample container of claim 5, wherein the heating element extends along a longitudinal axis of the outer wall.

9. The sample container of claim 5, wherein the heating element is cylindrical.

10. The sample container of claim 5, wherein the heating element is a hollow cylinder and a portion of the interior space is within the hollow cylinder.

11. The sample container of claim 5, wherein the heating element is deposited on an inner surface of the outer wall.

12. A method, comprising:
receiving, within a receptacle comprising an induction coil, a sample container comprising:
an electrically insulative outer wall surrounding an interior space containing a biological sample; and
a heating element within the interior space, the heating element comprising an electrically conductive portion; and
with the induction coil, inducing a current in a heating element of the sample container until the biological sample reaches a target temperature.

13. The method of claim 12, wherein, upon the receiving, a central axis of the induction coil extends through the sample container.

14. The method of claim 12, wherein, upon the receiving, a central axis of the sample container is aligned with a central axis of the induction coil.

15. The method of claim 12, wherein inducing the current comprises raising a temperature of the heating element above the target temperature for a duration of time.

16. The method of claim 12, wherein the heating element spans an entire height of the biological sample within the sample container.

17. The method of claim 12, wherein inducing the current comprises transmitting a plurality of sequential pulses of magnetic energy to the heating element.

18. The method of claim 12, wherein the target temperature is sufficient to promote lysis of cells within the biological sample.

19. The method of claim 12, wherein the target temperature is between 90° C. and 100° C.

20. The method of claim 12, wherein the target temperature is sufficient to promote a reduction in activity of substances in the biological sample which inhibit molecular amplification.
